(19) United States
(12) Patent Application Publication
(10) Pub. No.: US 2021/0118063 A1
(43) Pub. Date: Apr. 22, 2021

(54) MULTI-TIER SCALABLE MEDIA ANALYSIS

(71) Applicant: Google LLC, Mountain View, CA (US)

(72) Inventors: Haixia Zhao, Sunnyvale, CA (US); Derek Allan Butcher, Larkspur, CA (US)

(21) Appl. No.: 16/657,379

(22) Filed: Oct. 18, 2019

(51) Int. Cl. G06Q 50/00; H04L 29/08

(52) U.S. Cl. CPC G06Q 50/01; H04L 65/4069; H04L 67/18

(57) ABSTRACT

Methods, systems, and apparatus, including computer programs encoded on a computer storage medium, for enhancing user interaction with an interface. Methods include determining, using a first evaluation rule, a likelihood that content depicts objectionable material. The content is passed to rating entities for further evaluation based on the likelihood that the content depicts objectionable material. When the likelihood that the content depicts objectionable material is below a specified modification threshold, an unmodified version of the content is passed to the rating entities. When the likelihood that the content depicts objectionable material is above the specified modification threshold, the content is modified to attenuate the depiction of the objectionable material, and the modified content is passed to the rating entities. The rating entities return evaluation feedback indicating whether the content violates content guidelines. A distribution policy is enacted based on the evaluation feedback.

### BACKGROUND

This specification relates to data processing and analysis of media. The Internet provides access to media, e.g., streaming media, that can be uploaded by virtually any user. For example, users can create and upload video files and/or audio files to media sharing sites. Some sites that publish or distribute content for third parties (e.g., not administrators of the site) require users to comply with a set of content guidelines, also referred to as content guidelines, in order to share media on their sites or distribute content on behalf of those third parties. These content guidelines can include policies regarding content that is inappropriate to share on the site, and therefore not eligible for distribution.

### SUMMARY

In general, one innovative aspect of the subject matter described in this specification can be embodied in methods including the operations of determining, using a first evaluation rule, a likelihood that content depicts objectionable material; passing the content to a set of rating entities for further evaluation based on the likelihood that the content depicts objectionable material, including: when the likelihood that the content depicts objectionable material is below a specified modification threshold, passing an unmodified version of the content to the set of rating entities; and when the likelihood that the content depicts objectionable material is above the specified modification threshold: modifying the content to attenuate the depiction of the objectionable material; and passing the modified content to the set of rating entities; receiving, from the set of rating entities, evaluation feedback indicating whether the content violates content guidelines; and enacting a distribution policy based on the evaluation feedback, including: preventing distribution of the content when the evaluation feedback indicates that the content violates a content guideline; and distributing the content when the evaluation feedback indicates that the content does not violate the content guideline. Other embodiments of this aspect include corresponding methods, apparatus, and computer programs, configured to perform the actions of the methods, encoded on computer storage devices. These and other embodiments can each optionally include one or more of the following features.

Enacting a distribution policy can include enacting a geo-based distribution policy that specifies different distribution policies for different geographic regions. Methods can include determining, based on the evaluation feedback, that the content violates a first content guideline for a first geographic region, but does not violate a second content guideline for a second geographic region, wherein: preventing distribution of the content when the evaluation feedback indicates that the content violates a content guideline comprises preventing distribution of the content in the first geographic region based on the violation of the first content guideline; and distributing the content when the evaluation feedback indicates that the content does not violate the content guideline comprises distributing the content in the second geographic region based on the content not violating the second content guideline irrespective of whether the content violates the first content guideline of the first geographic region.

Methods can include generating the set of rating entities, including: determining one or more entity attributes that are considered required to reach consensus among the set of rating entities in a first context; and creating the set of rating entities to include only entities having the one or more entity attributes that are considered required to reach consensus among the set of rating entities in the particular context.

Methods can include generating a second set of rating entities that do not have at least one of the one or more entity attributes; obtaining, from the second set of rating entities, evaluation feedback indicating whether the content violates a content guideline; and determining whether the one or more entity attributes are required to reach consensus based on the evaluation feedback obtained from the second set of rating entities, including: determining that the one or more attributes are required to reach consensus when the evaluation feedback obtained from the second set of rating entities differs from the evaluation feedback received from the set of entities; and determining that the one or more attributes are not required to reach consensus when the evaluation feedback obtained from the second set of rating entities matches the evaluation feedback received from the set of entities.

Methods can include parsing the content into smaller portions of the content that each include less than all of the content, wherein: passing the content to a set of rating entities for further evaluation comprises passing each smaller portion of the content to a different subset of entities from among the set of entities for evaluation in parallel; and receiving evaluation feedback indicating whether the content violates a content guideline comprises receiving separate feedback for each smaller portion from the different subset of entities to which the smaller portion was passed.

Methods can include throttling an amount of content that is passed to the set of rating entities. Throttling the amount of content that is passed to the set of rating entities can include: for each different entity in the set of entities: determining an amount of content that has been passed to the different entity over a pre-specified amount of time; determining a badness score quantifying a level of inappropriateness of the content that has been passed to the different entity over the pre-specified amount of time; and preventing additional content from being passed to the different entity when (i) the amount of content that has been passed to the different entity over a pre-specified amount of time exceeds a threshold amount or (ii) the badness score exceeds a maximum acceptable badness score.

Determining the likelihood that content depicts objectionable material may comprise executing, by the one or more data processors, an automated rating entity that utilizes one or more of a skin detection algorithm, blood detection algorithm, object identification analysis, or speech recognition analysis.

Modifying the content to attenuate the depiction of the objectionable material may comprise any of one of blurring, pixelating, or muting, a portion of the content.

Particular embodiments of the subject matter described in this specification can be implemented so as to realize one or more of the following advantages. For example, the techniques discussed throughout this document enable a computer system to utilize a hierarchical evaluation process that reduces the risk that inappropriate content will be distributed to users, while also reducing the amount of time required to evaluate the content, thereby allowing for faster distribution of content. That is, inappropriate content is more accurately filtered before being presented to the public. The techniques discussed also help reduce the psychological impact of presentation of objectionable content to rating entities and/or users by modifying the content prior to presenting the content to the rating entities and/or dividing the content up into smaller sub-portions and providing each of the sub-portions to different rating entities. The techniques discussed also enable real-time evaluation of user-generated content prior to public distribution of the user-generated content, while also ensuring that the content is posted quickly by dividing the duration of the content (e.g., video) into smaller durations, and having each of the smaller durations evaluated simultaneously, thereby reducing the total time required to evaluate the entire duration of the content. The techniques can also determine whether the classification of evaluated content varies on a geographic basis or on a user-characteristic basis based on characteristics of rating entities and their respective classifications of the evaluated content, which can be used to block or allow distribution of content on a per-geographic region basis and/or on a per-user basis. That is, aspects of the disclosed subject matter address the technical problem of providing improved content filtering methods.

Another innovative aspect of the subject matter relates to a system comprising a data store storing one or more evaluation rules; and one or more data processors configured to interact with the one or more evaluation rules, and perform operations of any of the methods disclosed herein.

Another innovative aspect of the subject matter relates to a non-transitory computer readable medium storing instructions that, when executed by one or more data processing apparatus, cause the one or more data processing apparatus to perform operations comprising any of the methods disclosed herein.

Optional features of aspects may be combined with other aspects where appropriate.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is analyzed and distributed.

FIG. 2 is a block diagram of an example data flow for a hierarchical content evaluation process.

FIG. 3 is a block diagram depicting management of a set of rating entities.

FIG. 4 is a block diagram depicting a process of managing sets of rating entities based on entity attributes.

FIG. 5 is a block diagram depicting distribution of sub-portions of content to subsets of the rating entities.

FIG. 6 is a flow chart of an example multi-tier scalable media analysis process.

FIG. 7 is a block diagram of an example computer system that can be used to perform operations described.

Like reference numbers and designations in the various drawings indicate like elements.

### DETAILED DESCRIPTION

This document discloses methods, systems, apparatus, and computer readable media that are used to facilitate analyzing media items or other content, and enforcement of content distribution policies. In some implementations, a hierarchical evaluation process is used to reduce the risk that inappropriate content will be distributed to users, while also reducing the amount of time required to evaluate the content. As discussed in more detail below, the hierarchical evaluation process is implemented using a multi-level content evaluation and distribution system. Techniques can be implemented that improve the ability to identify inappropriate content prior to distribution of the inappropriate content, while also reducing the negative impact that the inappropriate content may have on rating entities that review and/or provide feedback regarding whether the content violates content guidelines. For example, as discussed in more detail below, when there is a high likelihood that content depicts objectionable material, the content can be modified in one or more ways so as to attenuate the depiction of the objectionable material. In some situations, the depiction of the objectionable material can be attenuated by pixelating or shortening the duration of the content during evaluation of the content by rating entities. This attenuation of the depiction of the objectionable material reduces the negative psychological impact of the objectionable material on the rating entities.

As used throughout this document, the phrases “content” and “media” refer to a discrete unit of digital content or digital information (e.g., a video clip, audio clip, multimedia clip, image, text, or another unit of content). Content can be electronically stored in a physical memory device as a single file or in a collection of files, and content can take the form of video files, audio files, multimedia files, image files, or text files and include advertising information. Content can be provided for distribution by various entities, and a content distribution system can distribute content to various sites and/or native applications for many different content generators, also referred to as content creators.

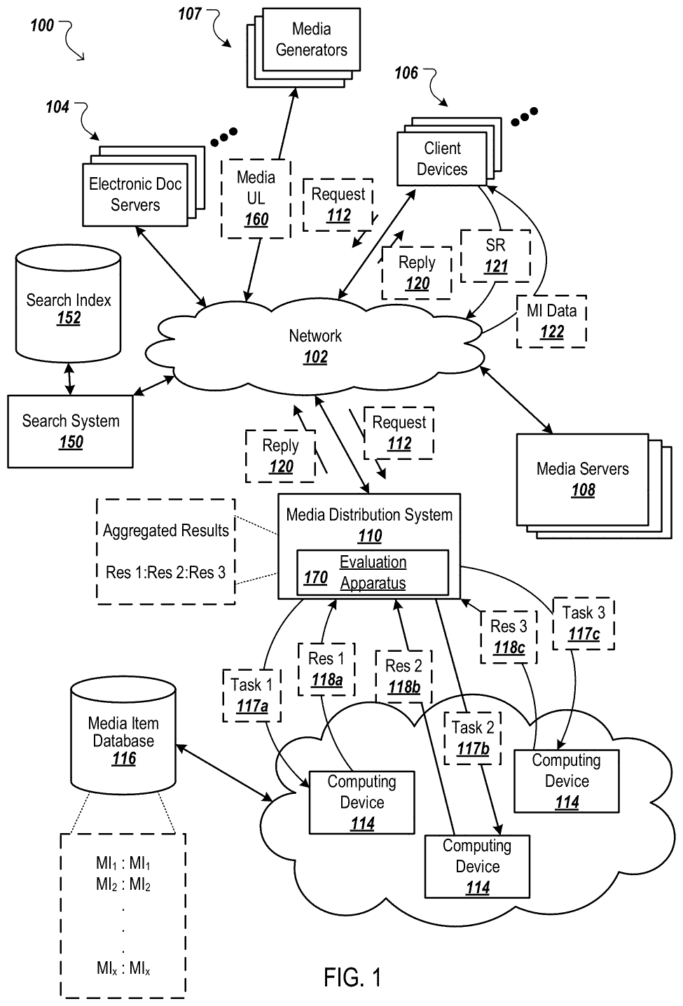

FIG. 1 is a block diagram of an example environment 100 in which digital components are distributed for presentation with electronic documents. The example environment 100 includes a network 102, such as a local area network (LAN), a wide area network (WAN), the Internet, or a combination thereof. The network 102 connects electronic document servers 104, client devices 106, media generators 107, media servers 108, and a media distribution system 110 (also referred to as a content distribution system (CDS)). The example environment 100 may include many different electronic document servers 104, client devices 106, media generators 107, and media servers 108.

A client device 106 is an electronic device that is capable of requesting and receiving resources over the network 102. Example client devices 106 include personal computers, mobile communication devices, and other devices that can send and receive data over the network 102. A client device 106 typically includes a user application, such as a web browser, to facilitate the sending and receiving of data over the network 102, but native applications executed by the client device 106 can also facilitate the sending and receiving of data over the network 102.

An electronic document is data that presents a set of content at a client device 106. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to client devices 106 by electronic document servers 104 (“Electronic Doc Servers”). For example, the electronic document servers 104 can include servers that host publisher websites. In this example, the client device 106 can initiate a request for a given publisher webpage, and the electronic document server 104 that hosts the given publisher webpage can respond to the request by sending machine executable instructions that initiate presentation of the given webpage at the client device 106.

In another example, the electronic document servers 104 can include app-servers from which client devices 106 can download apps. In this example, the client device 106 can download files required to install an app at the client device 106, and then execute the downloaded app locally. The downloaded app can be configured to present a combination of native content that is part of the application itself, as well as media that is generated outside of the application (e.g., by a media generator 107), and presented within the application.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a tag or script that causes the client device 106 to request content from the data source when the given electronic document is processed (e.g., rendered or executed) by a client device 106. The client device 106 integrates the content obtained from the data source into the given electronic document to create a composite electronic document including the content obtained from the data source.

In some situations, a given electronic document can include a media tag or media script that references the media distribution system 110. In these situations, the media tag or media script is executed by the client device 106 when the given electronic document is processed by the client device 106. Execution of the media tag or media script configures the client device 106 to generate a media request 112, which is transmitted over the network 102 to the media distribution system 110. For example, the media tag or media script can enable the client device 106 to generate a packetized data request including a header and payload data. The media request 112 can include event data specifying features such as a name (or network location) of a server from which media is being requested, a name (or network location) of the requesting device (e.g., the client device 106), and/or information that the media distribution system 110 can use to select one or more media items (e.g., different portions of media) provided in response to the request. The media request 112 is transmitted, by the client device 106, over the network 102 (e.g., a telecommunications network) to a server of the media distribution system 110.

The media request 112 can include event data specifying other event features, such as the electronic document being requested and characteristics of locations of the electronic document at which media can be presented. For example, event data specifying a reference (e.g., Uniform Resource Locator (URL)) to an electronic document (e.g., webpage or application) in which the media will be presented, available locations of the electronic documents that are available to present media, sizes of the available locations, and/or media types that are eligible for presentation in the locations can be provided to the media distribution system 110. Similarly, event data specifying keywords associated with the electronic document (“document keywords”) or entities (e.g., people, places, or things) that are referenced by the electronic document can also be included in the media request 112 (e.g., as payload data) and provided to the media distribution system 110 to facilitate identification of media that are eligible for presentation with the electronic document. The event data can also include a search query that was submitted from the client device 106 to obtain a search results page (e.g., a standard search results page or a media search results page that presents search results for audio and/or video media), and/or data specifying search results and/or textual, audible, or other visual content that is included in the search results.

Media requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Media requests 112 can be transmitted, for example, over a packetized network, and the media requests 112 themselves can be formatted as packetized data having a header and payload data. The header can specify a destination of the packet and the payload data can include any of the information discussed above.

The media distribution system 110, which includes one or more media distribution servers, chooses media items that will be presented with the given electronic document in response to receiving the media request 112 and/or using information included in the media request 112. In some implementations, a media item is selected in less than a second to avoid errors that could be caused by delayed selection of the media item. For example, delays in providing media in response to a media request 112 can result in page load errors at the client device 106 or cause portions of the electronic document to remain unpopulated even after other portions of the electronic document are presented at the client device 106. Also, as the delay in providing the media to the client device 106 increases, it is more likely that the electronic document will no longer be presented at the client device 106 when the media is delivered to the client device 106, thereby negatively impacting a user's experience with the electronic document. Further, delays in providing the media can result in a failed delivery of the media, for example, if the electronic document is no longer presented at the client device 106 when the media is provided.

In some implementations, the media distribution system 110 is implemented in a distributed computing system that includes, for example, a server and a set of multiple computing devices 114 that are interconnected and identify and distribute digital component in response to media requests 112. The set of multiple computing devices 114 operate together to identify a set of media items that are eligible to be presented in the electronic document from among a corpus of millions of available media items (MI₁₋ₓ). The millions of available media items can be indexed, for example, in a media item database 116. Each media item index entry can reference the corresponding media item and/or include distribution parameters (DP₁-DPₓ) that contribute to (e.g., condition or limit) the distribution/transmission of the corresponding media item. For example, the distribution parameters can contribute to the transmission of a media item by requiring that a media request include at least one criterion that matches (e.g., either exactly or with some pre-specified level of similarity) one of the distribution parameters of the media item.

In some implementations, the distribution parameters for a particular media item can include distribution keywords that must be matched (e.g., by electronic documents, document keywords, or terms specified in the media request 112) in order for the media item to be eligible for presentation. The distribution parameters can also require that the media request 112 include information specifying a particular geographic region (e.g., country or state) and/or information specifying that the media request 112 originated at a particular type of client device (e.g., mobile device or tablet device) in order for the media item to be eligible for presentation. The distribution parameters can also specify an eligibility value (e.g., ranking score or some other specified value) that is used for evaluating the eligibility of the media item for distribution/transmission (e.g., among other available digital components), as discussed in more detail below. In some situations, the eligibility value can specify an amount that will be submitted when a specific event is attributed to the media item (e.g., when an application is installed at a client device through interaction with the media item or otherwise attributable to presentation of the media item).

The identification of the eligible media items can be segmented into multiple tasks 117a-117c that are then assigned among computing devices within the set of multiple computing devices 114. For example, different computing devices in the set 114 can each analyze a different portion of the media item database 116 to identify various media items having distribution parameters that match information included in the media request 112. In some implementations, each given computing device in the set 114 can analyze a different data dimension (or set of dimensions) and pass (e.g., transmit) results (Res 1-Res 3) 118a-118c of the analysis back to the media distribution system 110. For example, the results 118a-118c provided by each of the computing devices in the set 114 may identify a subset of media items that are eligible for distribution in response to the media request and/or a subset of the media items that have certain distribution parameters. The identification of the subset of media items can include, for example, comparing the event data to the distribution parameters, and identifying the subset of media items having distribution parameters that match at least some features of the event data.

The media distribution system 110 aggregates the results 118a-118c received from the set of multiple computing devices 114 and uses information associated with the aggregated results to select one or more media items that will be provided in response to the media request 112. For example, the media distribution system 110 can select a set of winning media items (one or more media items) based on the outcome of one or more media evaluation processes. In turn, the media system 110 can generate and transmit, over the network 102, reply data 120 (e.g., digital data representing a reply) that enable the client device 106 to integrate the set of winning media items into the given electronic document, such that the set of winning media items and the content of the electronic document are presented together at a display of the client device 106.

In some implementations, the client device 106 executes instructions included in the reply data 120, which configures and enables the client device 106 to obtain the set of winning media items from one or more media servers 108. For example, the instructions in the reply data 120 can include a network location (e.g., a URL) and a script that causes the client device 106 to transmit a server request (SR) 121 to the media server 108 to obtain a given winning media item from the media server 108. In response to the server request 121, the media server 108 will identify the given winning media item specified in the server request 121 (e.g., within a database storing multiple media items) and transmit, to the client device 106, media item data (MI Data) 122 that presents the given winning media item in the electronic document at the client device 106.

To facilitate searching of electronic documents, the environment 100 can include a search system 150 that identifies the electronic documents by crawling and indexing the electronic documents (e.g., indexed based on the crawled content of the electronic documents). Data about the electronic documents can be indexed based on the electronic document with which the data are associated. The indexed and, optionally, cached copies of the electronic documents are stored in a search index 152 (e.g., hardware memory device(s)). Data that are associated with an electronic document is data that represents content included in the electronic document and/or metadata for the electronic document.

Client devices 106 can submit search queries to the search system 150 over the network 102. In response, the search system 150 accesses the search index 152 to identify electronic documents that are relevant to the search query. The search system 150 identifies the electronic documents in the form of search results and returns the search results to the client device 106 in search results page. A search result is data generated by the search system 150 that identifies an electronic document that is responsive (e.g., relevant) to a particular search query, and includes an active link (e.g., hypertext link) that causes a client device to request data from a specified location in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 106. Another example search result can include a title of streaming media, a snippet of text describing the streaming media, an image depicting contents of the streaming media, and/or a URL to a location from which the streaming media can be downloaded to the client device 106. Like other electronic documents search results pages can include one or more slots in which digital components (e.g., advertisements, video clips, audio clips, images, or other digital components) can be presented.

Media items can be generated by the media generators 107, and uploaded to the media servers 108 in the form of a media upload (Media UL) 160. The media upload 160 can take the form of a file transfer, e.g., a transfer of an existing video file, image file, or audio file. Alternatively, or additionally, the media upload can take the form of a “live stream” or “real time stream capture.” The live stream and real time stream captures can differ from the file transfer in that these types of media uploads can generally happen in real time as the media is captured, i.e., without having to first record the media locally, and then upload the media by way of a file transfer.

The media generators 107 can include professional organizations (or companies) that generate media for distribution to users as part of a business venture, and can also include individuals that upload content to share with other users. For example, individuals can upload video or audio files to a media sharing site (or application) to share that media with other users around the globe. Similarly, individuals can upload video or audio files to a social network site (e.g., by posting the video or audio to their account or stream), to be viewed by their friends, specified social network users, or all users of the social network. The ability of individuals to upload media at essentially any time of the day, any day of the week, and the sheer volume of media uploads by individuals makes it difficult to enforce content guidelines related to restrictions on inappropriate content without severely increasing the amount of time between the time a media generator 107 initiates the media upload 160 and the time at which the media is available for distribution by the media distribution system 110 and/or the media servers 108. Furthermore, the content guidelines for a particular site/application may vary on a geographic basis, and content norms of what is considered inappropriate content can vary on a geographic basis, belief-based basis, and/or over time (e.g., in view of recent social events). These variations in what constitutes inappropriate content makes it even more difficult to effectively identify inappropriate content in a timely manner.

To facilitate the analysis of media, the media distribution system 110 includes an evaluation apparatus 170. As discussed in more detail below, the evaluation apparatus 170 implements a hierarchical media review technique that uses a combination of machine automated review entities and live review entities. The automated review entities can determine a likelihood that content (e.g., media items) uploaded by media generators 107 depict objectionable material (e.g., content that either violates specified content guidelines or is otherwise objectionable based on social standards for a given community of users). As discussed in more detail below, some (or all) of the content reviewed by the machine automated review entities are passed to the live review entities for further analysis as to whether the content depicts objectionable material.

In some implementations, the set of rating entities to which a given portion of content is provided can be selected in a manner that ensures consensus as to the classification of the content can be reached (e.g., at least a specified portion, or percentage, of rating entities in the group agree on the classification of the content). In some situations, that means the evaluation apparatus 170 select different groups of rating entities based on geographic location (or another distinguishing feature) to determine whether the content depicts material that is deemed objectionable in one geographic region, but deemed acceptable in another geographic region. In some situations, additional rating entities can be added to a particular group of rating entities by the evaluation apparatus 170 if consensus as to the appropriateness of the content is not reached using an initially selected group of rating entities. Further, the content can be modified by the evaluation apparatus 170 in situations where one or more prior evaluations of the content indicated that there is a high likelihood (but not a certainty) that the content includes objectionable material. For example, the content can be blurred, pixelated, muted, or otherwise attenuated by the evaluation apparatus to reduce the impact of that potentially objectionable material on any subsequent rating entity that is exposed to the questionable content. The modified content is then provided to additional rating entities for further analysis and/or evaluation.

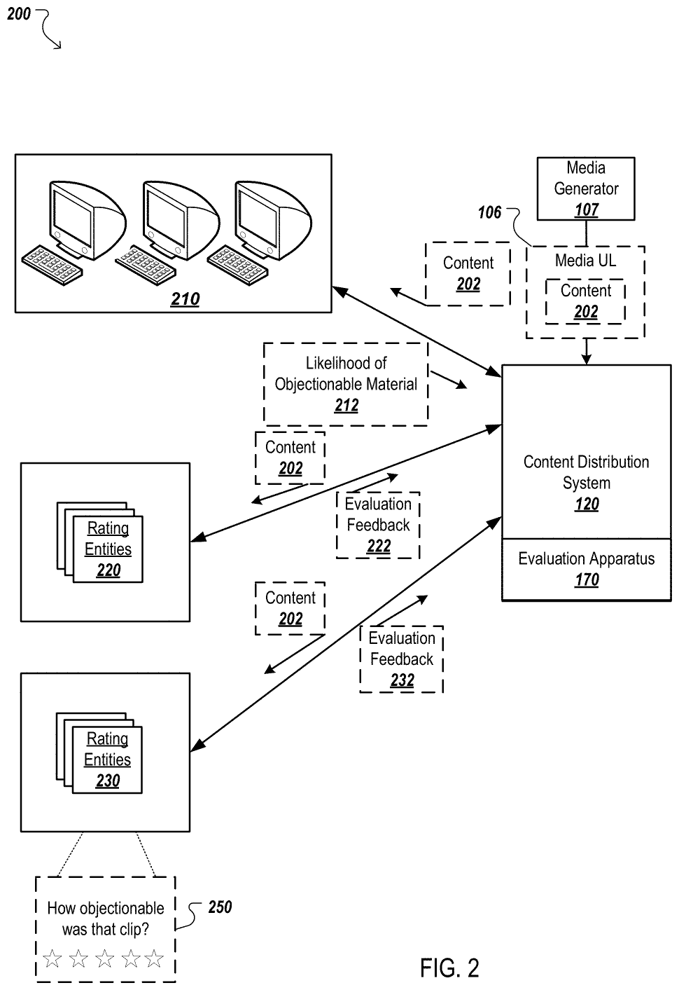

FIG. 2 is a block diagram of an example hierarchical media evaluation process 200 that can be implemented by the evaluation apparatus 170. The evaluation process 200 is hierarchical (or multi-tier) in nature because it begins with an initial analysis of content by a first set of rating entities 210, and subsequent actions and/or analysis of the content is performed by different sets of rating entities (e.g., ratings entities 220 and/or rating entities 230) based on the feedback obtained from the initial analysis. Similarly, different actions and/or further analysis can be performed at each subsequent level of the hierarchical review process. For example, during the initial analysis (e.g., a highest or first level of the hierarchical review process), media can be analyzed and/or evaluated with respect to a first set of content guidelines (e.g., originality, violence, and/or adult material), while the media can be analyzed or evaluated for a second set of content guidelines (e.g., sound quality, video quality, and/or accuracy of a media description) at a lower level (e.g., second level) of the hierarchical review process. As discussed in more detail below, aspects of the media that are evaluated at one level of the hierarchical review process can be evaluated again at other levels of the hierarchical review process.

The process 200 can begin with the content distribution system (CDS) 110, which includes the evaluation apparatus 170, receiving a media upload 160 from a media generator 107. The media upload 160 includes content 202 that is evaluated by the evaluation apparatus 170 prior to full public distribution (e.g., prior to posting to a video sharing site or distributing in slots of web pages or applications). The content 202 can be video content, audio content, or a combination of video and audio content. The media upload can also include other information, such as a source of the media upload 160 (e.g., the media generator that submitted the media upload 160), descriptive information about the content 202 in the media upload, a target distribution site for the content 202, a timestamp of when the media upload 160 was initiated, and/or a unique identifier for the content 202 included in the media upload 160.

Upon receiving the media upload 160, the evaluation apparatus 170 triggers an initial evaluation of the content 202 according to a first evaluation rule. In some implementations, the evaluation apparatus 170 triggers the initial evaluation by conducting an initial evaluation of the content 202 using the first evaluation rule. In other implementations, the evaluation apparatus 170 triggers the initial evaluation by passing the content 202 to a set of automated rating entities 210.

The initial evaluation of the content 202 can be performed by the evaluation apparatus 170 or the set of automated rating entities 210 using one or more algorithmic and/or machine learning methods. The initial evaluation of the content 202 can include video analytics, skin detection algorithms, violence detection algorithms, object detection algorithms, and/or language detection algorithms. The output of the initial evaluation of the content 202 can be provided in the form of a likelihood of objectionable material 212. In some implementations, the likelihood of objectionable material 212 is a numeric value that represents the overall likelihood that the content 202 fails to meet content guidelines. For example, the likelihood of objectionable material can be a number on a scale from 0-10, where a number closer to 0 indicates that the content 202 has a lower determined likelihood of depicting objectionable material, and a number closer to 10 indicates a higher likelihood that the content 202 depicts objectionable material. Of course, the likelihood of objectionable material 212 can be expressed using any appropriate scale. Examples of common objectionable material that may be detected through the initial evaluation of the content 202 include pornography, cursing, and bloody scenes.

Using the determined likelihood of objectionable material 212, the evaluation apparatus 170 can make a determination as to whether the content 202 qualifies for public distribution, requires further evaluation, or is not qualified for public distribution. In some implementations, this determination is made by comparing the likelihood of objectionable material 212 to one or more thresholds. For example, the evaluation apparatus 170 can disqualify the content 202 from public distribution when the likelihood of objectionable material 212 is greater than a specified objection threshold (e.g., a number greater than 8 on a scale of 0-10), and pass the content 202 to another set of rating entities (e.g., rating entities 220) for further evaluation when the likelihood of objectionable material 212 is lower than the objection threshold. In another example, the evaluation apparatus 107 can qualify the content 202 as ready for public distribution when the likelihood of objectionable material 212 is lower than a specified safe threshold (e.g., lower than 2 on a scale of 0-10), and pass the content 202 to the other set of rating entities when the likelihood of objectionable material 212 is greater than the safe threshold. In yet another example, the evaluation apparatus 170 can use both the safe threshold and the objection threshold in a manner such that the content 202 is only passed to the other set of rating entities when the likelihood of objectionable material 212 is between the safe threshold and the objection threshold. In some situations, the evaluation apparatus 170 can pass the content 202 to another set of rating entities irrespective of the likelihood of objectionable material 212 determined in the initial evaluation.

The likelihood of objectionable material 212 can also be used for determining whether the content 202 should be modified before passing the content 202 to another set of rating entities. In some implementations, the evaluation apparatus 170 passes the content 202 to one or more other sets of rating entities without modification when the likelihood of objectionable material 212 is less than a specified modification threshold. However, when the likelihood of objectionable material 212 meets (e.g., is equal to or greater than) the modification threshold, the evaluation apparatus 170 can modify the content 202 prior to passing the content 202 to another set of rating entities (e.g., a set of rating entities in the second level or another lower level of the hierarchical evaluation process). In some implementations, the evaluation apparatus 170 can modify the content 202 through blurring, pixilation or changing color of the visual content, which reduces the psychological impact of the content 202 on the rating entities to which the content is passed.

In some implementations, the evaluation apparatus 170 passes the content 202 (either modified or unmodified) to a mid-level set of rating entities 220 that are at one or more lower levels of the hierarchical evaluation process. This mid-level set of rating entities 220 can be, or include, human evaluators who are employed to review content for objectionable material and/or who have registered to provide the service of content evaluation based on certain incentives. In some implementations, the rating entities are characterized by certain attributes. Example attributes can include age range, geographic location, online activity and/or a rating history of the human evaluator. The attributes of the rating entities can be submitted by those rating entities when they register to be a rating entity. The rating history can indicate types of content previously rated by the rating entity, ratings applied to the content, a correlation score of the rating entities prior ratings to the overall rating of content, among other information. The mid-level set of rating entities 220 can be requested to evaluate the content on the same and/or different factors than those considered in the initial evaluation.

The mid-level set of rating entities 220 to which the content 202 is passed can be chosen from a pool of rating entities. The mid-level set of rating entities 220 (also referred to as mid-raters 220) can be chosen in a manner that is likely to provide a robust evaluation of the content 202 depending on the context of the content 202. For example, if the content 202 is only going to be accessible in a particular geographic region (e.g., a single country), the mid-raters 220 can be chosen to include only rating entities from that particular geographic region. Meanwhile, the mid-raters 220 can also be chosen so as to provide diversity, which can reveal whether the content 202 is broadly acceptable (or objectionable), and/or whether certain sub-groups of the population may differ in their determination of whether the content 202 is objectionable. For example, a particular set of mid-raters 220 may include only rating entities that are located in the United States, but have a diverse set of other attributes. Meanwhile, another set of mid-raters 220 can include only rating entities that are located in India, but otherwise have a diverse set of other attributes. In this example, the construct of the different mid-raters 220 can provide insights as to whether the content 202 is generally considered objectionable in the United States and India, as well as provide information as to the differences between how objectionable the content is considered in the United States versus India.

To facilitate these determinations, the evaluation apparatus 170 passes the content 202 to each of the chosen mid-raters 220, and receives evaluation feedback 222 from those mid-raters 220. The content 202 can be passed to the mid-raters 220, for example, through a dedicated application or web page that is password protected, such that access to the content 202 is restricted to the mid-raters who have registered to rate content.

The evaluation feedback 222 received by the evaluation apparatus 170 can specify a score that represents the degree of how objectionable the content 202 is. For example, by way of the evaluation feedback, each mid-rater 220 (or any other rating entity) can provide a score on a scale of 0 to 10 wherein 0 refers to the least objectionable material and 10 refers to the most objectionable material. In another example, the evaluation feedback can specify a vote in favor or against the content 202 being objectionable. For example, voting YES with respect to the content 202 may refer to a vote that the content depicts objectionable material and voting NO with respect to the content 202 may refer to a vote that the content 202 does not depict objectionable material. The evaluation apparatus 170 can use the evaluation feedback 222 to evaluate whether the content 202 violates one or more content guidelines, as discussed in more detail below.

In some situations, the evaluation apparatus 170 requests more detailed information from rating entities beyond simply whether the content 202 depicts objectionable material. For example, the evaluation apparatus 170 can request information as to the type of material (e.g., adult-themed, violent, bloody, drug use, etc.) being depicted by the content 202, and can index the content 202 to the types of material that are depicted by the content, which helps facilitate the determination as to whether the content 202 violates specified content guidelines.

As discussed in more detail below, the evaluation apparatus 170 can determine whether there is consensus among the mid-raters 220 (or other rating entities) as to whether the content 202 depicts objectionable material or whether the content 202 does not depict objectionable material. In some situations, the determination as to whether consensus is reached among the mid-raters 220 can be made based on a percentage of the mid-raters 220 that submitted matching evaluation feedback. For example, if the evaluation feedback 222 submitted by all of the mid-raters 220 (or at least a specified portion of the mid-raters) indicated that the content 202 depicts objectionable material, the evaluation apparatus 170 can classify the content 202 as depicting objectionable material. Similarly, if the evaluation feedback 222 submitted by all of the mid-raters 220 (or at least a specified portion of the mid-raters) indicated that the content 202 does not depict objectionable material, the evaluation apparatus 170 can classify the content 202 as not depicting objectionable material. In turn, the evaluation apparatus 170 can proceed to determine whether the content 202 qualifies for public distribution, requires further evaluation, or is not qualified for public distribution in a manner similar to that discussed above. Furthermore, the evaluation apparatus 170 can also again determine whether the content should be modified prior to further distribution to additional rating entities (e.g., additional mid-raters 220 or additional raters at another level of the hierarchical structure).

The evaluation apparatus 170 can continue to pass the content 202 to additional sets of rating entities to collect additional evaluation feedback about the content 202. For example, after passing the content 202 to the mid-raters 220, the evaluation apparatus 170 can proceed to pass the content 202 to a set of general raters (also referred to as general raters) 230. The general raters 230 can be rating entities that are not employed, and have not registered, to rate content. For example, the general raters 230 can be regular users to whom the content 202 is presented, e.g., in a video sharing site, in a slot of a web page or application, or in another online resource. The general raters 230 can be chosen in a manner similar to that discussed above with reference to the mid-raters 220.

The presentation of the content 202 can include (e.g., end with) a request for evaluation feedback 232, and controls for submission of the evaluation feedback. For example, the content 202 provided to the general raters 230 can be a 5 second video clip that concludes with an endcap 250 (e.g., a final content presentation) asking the general rater 230 to specify their assessment of how objectionable the video clip was. As depicted, the general rater can select a number of stars to express their opinion as to how objectionable the video clip was. Other techniques can be used to solicit and obtain the evaluation feedback 232 from the general raters 230. For example, the endcap 250 could ask the general rater 230 whether the video clip depicted violence or another category of content that may violate specified content guidelines. Furthermore, the evaluation apparatus 170 can follow up with more specific requests, such as reasons why the general rater 230 considered the content objectionable (e.g., violence, adult themes, alcohol, etc.) so as to obtain more detailed evaluation feedback 232.

As discussed in more detail below, the evaluation apparatus 170 can determine whether there is consensus among the general raters 230 (or other rating entities) as to whether the content 202 depicts objectionable material or whether the content 202 does not depict objectionable material. In some situations, the determination as to whether consensus is reached among the general raters 230 can be made in a manner similar to that discussed above with reference to the mid-raters 220. In turn, the evaluation apparatus 170 can proceed to determine whether the content 202 qualifies for public distribution, requires further evaluation, or is not qualified for public distribution in a manner similar to that discussed above. Furthermore, the evaluation apparatus 170 can also again determine whether the content should be modified prior to further distribution to additional rating entities.

At any point in the hierarchical evaluation process, (e.g., at the mid-rater level or the general rater level), the evaluation apparatus 170 may determine that consensus among the rating entities has not been reached. In response, the evaluation apparatus 170 can modify the makeup of the rating entities being passed the content 202 in an effort to reach consensus among the rating entities and/or determine similarities among subsets of the rating entities that are submitting matching evaluation feedback. For example, while consensus among the initially chosen set of mid-raters 220 may not be reached overall, analysis of the evaluation feedback 222 received from the mid-raters 220 may reveal that the mid-raters 220 in one particular geographic region consistently classify the content 202 as depicting objectionable material, while the mid-raters 220 in a different particular geographic region consistently classify the content 202 as not depicting objectionable material. This type of information can be used to determine how the content 202 is distributed in different geographic regions and/or whether a content warning should be appended to the content. The modification of the sets of rating entities is discussed in more detail below.

The evaluation apparatus 170 uses the evaluation feedback 170 to determine whether the content 202 violates content guidelines. As discussed above, the content guidelines specify material that is not allowed to be depicted by media uploaded to the service that specifies the content guidelines. For example, a video sharing site may have content guidelines that prohibit adult-themed content, while an advertising distribution system may prohibit content that depicts drug use or extreme violence. In some implementations, the evaluation apparatus 170 can compare the evaluation feedback 222 and 232 and/or the results of the initial evaluation to the content guidelines to determine whether the content 202 depicts material that is prohibited by the content guidelines. When the evaluation apparatus 170 determines (e.g., based on the comparison) that the content 202 depicts material that is not allowed by the content guidelines, the content 202 is deemed to violate the content guidelines, and distribution of the content 202 is prevented. When the evaluation apparatus 170 determines (e.g., based on the comparison) that the content 202 does not depict material prohibited by the content guidelines, the content 202 is deemed to be in compliance with the content guidelines, and distribution of the content 202 can proceed.

In some situations, the content guidelines for a particular service will vary on a geographic basis, or on some other basis. In these situations, the evaluation apparatus 170 can enact distribution policies on a per-geographic basis or on some other basis. For example, content depicting drug use may be completely restricted/prevented in one geographic region, while being distributed with a content warning in another geographic region.

To facilitate the use of per-geographic basis distribution policies, the evaluation apparatus 170 can create different groups of rating entities that evaluate content for different geographic regions. For example, the evaluation apparatus 170 can create a first set of rating entities that evaluate the content 202 for geographic region A, and a second set of rating entities that evaluate the content 202 for geographic region B. In some implementations, the rating entities in the first set can all be located in geographic region A, while the rating entities in the second set can all be located in geographic region B. This delineation of rating entities in each group ensures that the feedback evaluation received from each group will accurately reflect the evaluation of the content 202 by rating entities in the relevant geographic regions. Alternatively, or additionally, the rating entities in each group can be trained, or knowledgeable, about the content guidelines for the respective geographic regions, and provide evaluation feedback consistent with the content guidelines.

The evaluation apparatus 170, upon receiving the evaluation feedback from each of the two sets of rating entities, determines whether the content 202 violates any content guidelines specific to geographic region A or geographic region B. For example, the evaluation apparatus 170 can determine, from the evaluation feedback that the content 202 does not violate a content guideline for geographic location A, but violates a content guideline for geographic location B. In such a situation, the evaluation apparatus can enable distribution of the content 202 to users in geographic region A, while preventing distribution of the content 202 in geographic location B.

In some implementations, the evaluation of the content requires the entity in the set of rating entities to have a certain skill. For example, an audio clip in a specific language. In order to evaluate the audio clip for vulgar words or comments that are considered objectionable, the rating entities should be able to understand the specific language. In these implementations, information about the languages spoken and/or understood by the rating entities can be considered when forming the sets of rating entities to ensure that the rating entities can accurately determine whether the audio clip is depicting objectionable language.

More generally, the evaluation apparatus 170 can determine the attributes that a rating entity needs to have in order to effectively analyze the content 202 for purposes of determining whether the content 202 depicts objectionable material that violates content guidelines. For example, it may be that only rating entities who have been trained on, or previously accurately classified content with respect to, a specific content guideline should be relied upon for classifying content with respect to that specified content guideline. In this example, the evaluation apparatus 170 can create the set of rating entities to only include those rating entities with the appropriate level of knowledge with respect to the specified content guideline.

In some situations, evaluation of the content 202, by the set of rating entities, may not result in consensus as to the classification of the content 202 (e.g., whether the content depicts objectionable material). For example, the set of rating entities may differ in their classification of the content 202, which could be considered a tie between the content 202 being considered objectionable, and the content 202 being considered not objectionable. In such cases, the evaluation apparatus 170 can add new (e.g., additional) rating entities to the set of rating entities until consensus is reached (e.g., a specified portion of the rating entities classify the content the same way).

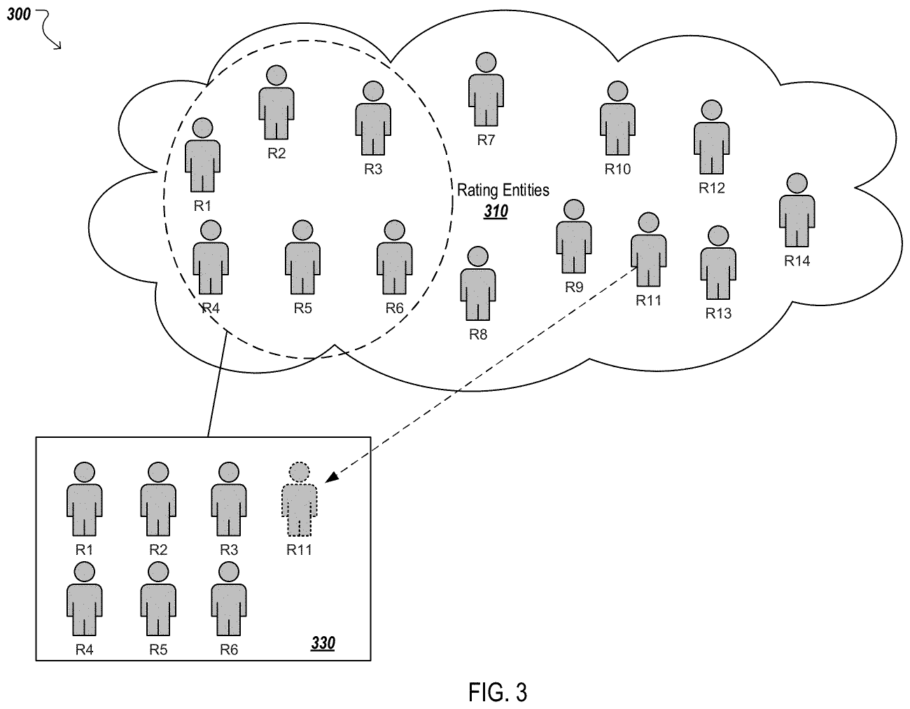

FIG. 3 is a block diagram 300 depicting management of a set of rating entities 330, which can include adding rating entities to the set of rating entities 330 when consensus as to the classification of the content is not reached. The set of rating entities 330 is formed from a pool of rating entities 310 that are available to analyze content. In some implementations, the set of rating entities 330 can initially be formed to include a diverse set of rating entities (e.g., from various different geographic regions), and evaluation feedback regarding a particular portion of content can be received from the initial set of rating entities. If consensus is reached based on the evaluation feedback received from the initial set of rating entities, the evaluation apparatus can proceed to enact a distribution policy based on the evaluation feedback. When consensus is not reached using the evaluation feedback from the initial set of rating entities, the evaluation apparatus can modify the set of rating entities in an effort to obtain consensus, as discussed in more detail below.

For purposes of example, assume that the evaluation apparatus selects rating entities R1-R6 to create the set of rating entities 330. The rating entities R1-R6 can be selected to have differing attributes to create a diverse set of rating entities to initially analyze a particular portion of content. For example, the rating entities can be from at least two different geographic regions.

In this example, the evaluation apparatus provides a particular portion of content to each of the rating entities (e.g., R1-R6) in the set of rating entities 330, and receives evaluation feedback from each of those rating entities. Assume that the evaluation feedback received from the rating entities does not result in consensus as to the classification of the particular portion of content. For example, assume that the evaluation feedback from R1-R3 classify the content as depicting objectionable material, while the evaluation feedback from R4-R6 classify the content as depicting material that is not objectionable. In this situation, the evaluation apparatus can take action in an attempt to arrive at consensus.

In some implementations, the evaluation apparatus can add additional rating entities to the set of rating entities 330 to attempt to arrive at consensus as to the classification of content. For example, the evaluation apparatus can add rating entity R11 to the set of rating entities 330, provide the particular portion of content to R11, and receive evaluation feedback from R11. In this example, the evaluation feedback from R11 will break the tie, and the evaluation apparatus could simply consider a consensus reached based on the tie being broken, e.g., by classifying the content based on the evaluation feedback from R11. However, in some implementations, the evaluation apparatus requires more than a simple majority to determine that consensus is reached. For example, the evaluation apparatus could require at least 70% (or another specified portion, e.g., 60%, 80%, 85%, 90%, etc.) of the evaluation feedback match to consider consensus reached. Thus, the evaluation apparatus could select more than one additional rating entity to be added to the set of rating entities 330, in an effort to reach consensus.

When the addition of more rating entities to the set of rating entities 330 results in consensus being reached, the evaluation apparatus can classify the content according to the consensus, and proceed to enact a distribution policy based on the consensus. When the addition of more rating entities to the set of rating entities does not result in consensus being reached, the evaluation apparatus can determine whether there are common attributes among those entities that have submitted matching evaluation feedback, and then take action based on that determination.

Continuing with the example above, assume that R1, R2, and R3 are all from geographic region A, while R4, R5, and R6 are all from geographic region B. In this example, the evaluation apparatus can compare the attributes of the rating entities, and determine that all of the rating entities from geographic region A classify the content as depicting objectionable material, while all of the rating entities from geographic region B classify the content as depicting material that is not objectionable. In this example, the evaluation apparatus can enact a per-geographic region distribution policy in which the content is enabled for distribution in geographic region A, and prevented from distribution (or distributed with a content warning) in geographic region B. Alternatively, or additionally, the evaluation apparatus can add additional rating entities to the set of rating entities in an effort to confirm the correlation between the geographic locations of the rating entities to the evaluation feedback.

For example, the evaluation apparatus can search the pool of rating entities 310 for additional rating entities that are located in geographic region A and additional rating entities that are located in geographic region B. These additional rating entities can be provided the content, and evaluation feedback from these additional rating entities can be analyzed to determine whether consensus among the rating entities from geographic region A is reached, and whether consensus among the rating entities from geographic region B is reached. When consensus is reached among the subsets of the set of rating entities, geographic based distribution policies can be enacted, as discussed in other portions of this document.

The example above refers to the identification of geo-based differences in the classification of content, but similarities between the classifications of content by rating entities can be correlated to any number of rating entity attributes. For example, rating entities that have previously rated a particular type of content at least a specified number of times may rate that particular type of content (or another type of content) more similarly than rating entities that have not rated that particular type of content as frequently, or at all. Similarly, the classifications of content by rating entities may differ based on the generations of the rating entities. For example, the classifications of a particular portion of content by baby boomers may be very similar, but differ from the classifications of that particular portion of content by millennials. As discussed in more detail below, the evaluation apparatus can identify the attributes that are common among those rating entities that submit matching evaluation feedback (e.g., submit a same classification of a particular portion, or type, of content), and use those identified similarities as it creates sets of rating entities to analyze additional content.

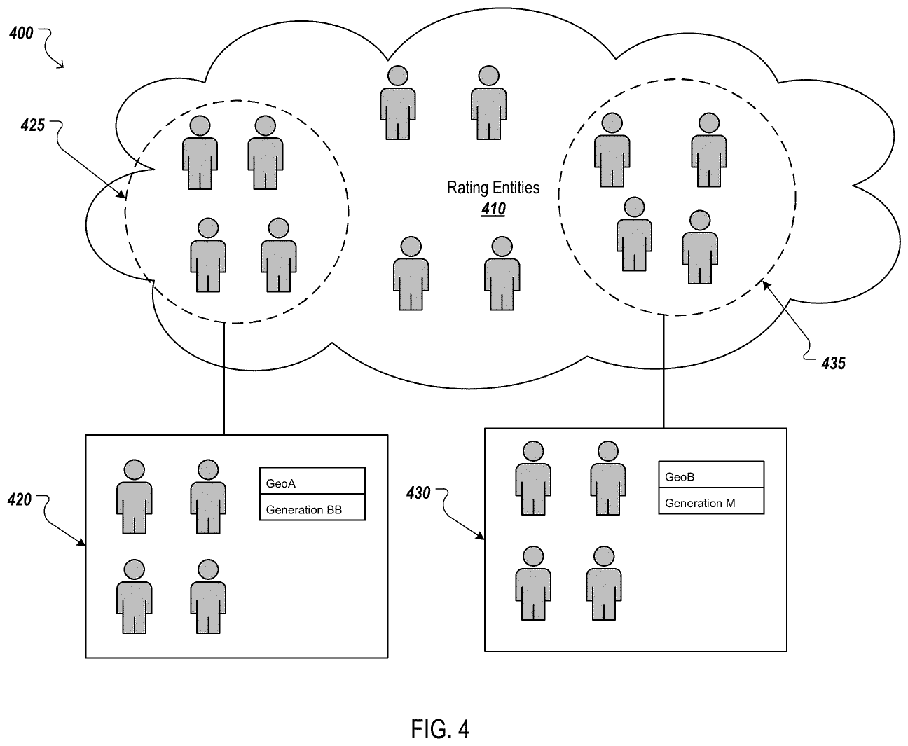

FIG. 4 is a block diagram 400 depicting managing sets of rating entities based on entity attributes. In FIG. 4, sets of rating entities that will analyze a portion of content are created based on the pool of rating entities 410, which can include all rating entities that are available to analyze content. In some implementations, the sets of rating entities are created by the evaluation apparatus based on one or more attributes of the rating entities. For example, the evaluation apparatus can use historical information about previous content analysis to determine the attributes of rating entities that are considered required to reach consensus as to the classification of the portion of content among the rating entities. More specifically, previous analysis of similar content may have revealed that classifications of the type of content to be rated has differed on a geographic, generational, or experience basis. The evaluation apparatus can use the information revealed from the previous content analysis to create different sets of rating entities to evaluate the portion of content, which can provide a context-specific classification of the portion of content (e.g., whether the content depicts objectionable material in different contexts, such as when delivered to different audiences).

For purposes of example, assume that the evaluation apparatus has determined that the portion of content to be analyzed by rating entities is related to a particular genre of content, and that previous analysis of content in that particular genre indicates that the evaluation feedback receives about that particular genre of content has differed based on the geographic regions of the rating entities as well as a generational basis. In this example, the evaluation apparatus can use this historical information to create multiple sets of rating entities that will evaluate the portion of content, and facilitate the enactment of distribution policies on the basis of context (e.g., the geographic region of distribution and/or the likely, or intended, audience).

More specifically, the evaluation apparatus can create a first set of rating entities 420, and a second set of rating entities 430, that will each provide evaluation feedback for the portion of content. Continuing with the example above, the evaluation apparatus can select, from the population of entities 410, those rating entities that are from geographic region A and baby boomers, and create the first set of rating entities 420. For example, the rating entities in the dashed circle 425, have this combination of attributes, such that the evaluation apparatus includes these rating entities in the first set of rating entities 420. The evaluation apparatus can also select, from the population of entities 410, those entities that are from geographic region B and millennials. For example, the rating entities in the dashed circle 435, have this combination of attributes, such that the evaluation apparatus includes these rating entities in the first set of rating entities 430. In this example, the evaluation apparatus creates these sets of rating entities based on the historical information indicating that these attributes are highly correlated to different classifications of the particular genre of content, such that creating sets of rating entities on the basis of these attributes is considered required to reach consensus among the rating entities in each set. The evaluation apparatus could also create a control set of rating entities, or first create the diverse initial set of rating entities discussed above, and then determine the attributes that are required to reach consensus only after consensus is not reached.

Continuing with this example, the evaluation apparatus provides the content to the rating entities in each of the first set of rating entities 420 and the second set of rating entities 430, and obtains evaluation feedback from the rating entities. The evaluation apparatus then determines how each set of rating entities classified the content, e.g., based on the consensus of the evaluation feedback it receives from the rating entities in each set of rating entities 420, 430.

Assume for purposes of example, that the first set of rating entities classified the portion of content as depicting objectionable material, which is considered a content guideline violation, while the second set of rating entities classified the portion of content as depicting material that was not objectionable. In this example, the evaluation apparatus can index the portion of content to the context of the classifications (e.g., the geo and generational attributes of the rating entities), as well as the classifications themselves. Indexing the content in this way enables the evaluation apparatus to enact distribution policies on a per-context basis. For example, for a given distribution opportunity (e.g., content request or push message), the evaluation apparatus can collect contextual information (e.g., the geo and/or generational information related to the intended audience), and either distribute the content or prevent the distribution based on the classification that is indexed to that particular context.

As discussed above, the content that has been deemed to include objectionable content can be modified before it is further distributed to rating entities. In some implementations, the content is modified in a manner that decreases the negative effect of the content on the rating entities that are evaluating the content. For example, as discussed above, the content can be visually pixelated or blurred, and audibly modified to reduce the volume, mute, bleep, or otherwise attenuate the presentation of audibly objectionable material (e.g., cursing, screaming, etc.). Additionally, or alternatively, the content can be segmented, so that each rating entity is provided less than all of the content, which is referred to as a sub-portion of the content. In addition to reducing the effect of the objectionable content on the rating entities, the evaluation of the sub-portions of the content by different rating entities (e.g., in parallel), also enable the evaluation of the content to be completed in a fraction of the time it would take a single rating entity to evaluate the entire duration of the content, thereby reducing the delay in distributing the content caused by the evaluation process.

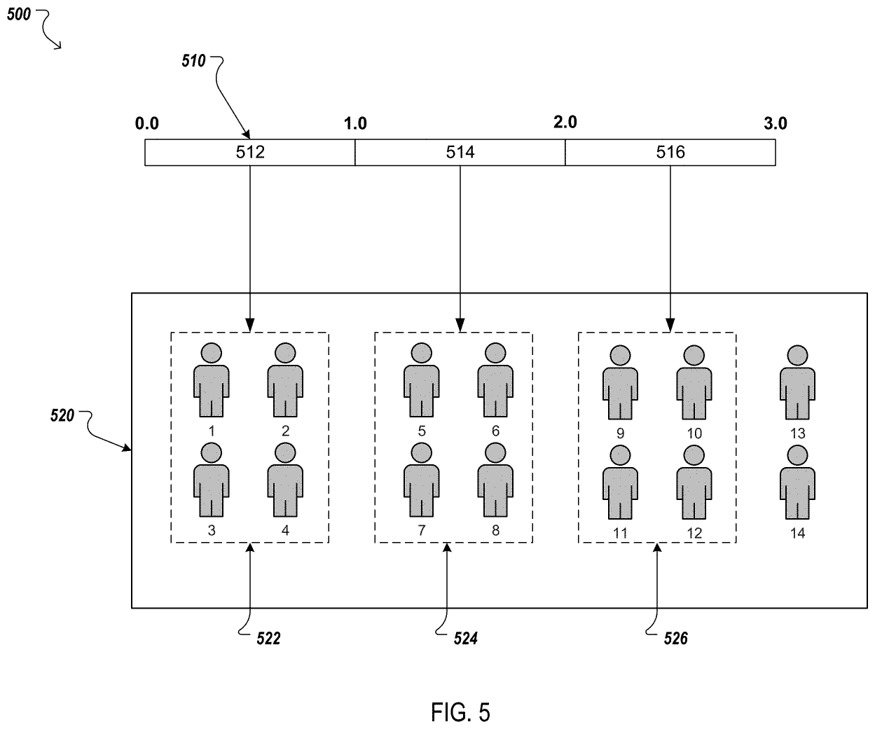

FIG. 5 is a block diagram depicting distribution of sub-portions of content to subsets of the rating entities. FIG. 5 depicts a video clip 510 having a length 3 of minutes that is to be evaluated by a set of rating entities 520. The set of rating entities 520 can be created by the evaluation apparatus using any appropriate technique, including the techniques discussed above.

To facilitate faster evaluation of the video clip 510, and to reduce the negative effects of objectionable content on the rating entities in the set of rating entities 520, the evaluation apparatus can parse the video clip 510 into multiple different sub-portions, and provide the different sub-portions to different subsets of rating entities in the set of rating entities 510. The sub-portions of the video clip 510 can all have a duration less than the total duration of the video clip 510. In FIG. 5, the video clip 510 is parsed into three sub-portions 512, 514, and 516. Those different sub-portions 512, 514, and 516 can be separately passed to three different subsets of rating entities 522, 524, and 526. For example, the sub-portion 512 can be passed to the subset 522, the sub-portion 514 can be passed to the subset 524, and the sub-portion 516 can be passed to the subset 526. In FIG. 5, the video clip of length 3 minutes is divided into 3 portions and each portion of the video clip has a duration of 1 min. The duration of each sub-portion can be any appropriate duration (e.g., 10 seconds, 30 seconds, 45 seconds, 1 min, etc.). The evaluation apparatus receives evaluation feedback for each of the sub-portions 512, 514, and 516, and determines whether the content violates any content guidelines based on the evaluation feedback, as discussed above. In some implementations, the video clip 510 (or other content) is deemed to violate a content guideline when the evaluation feedback for any of the sub-portions 512, 514, and 516 indicate that a content guideline is violated.

In some implementations, the evaluation apparatus throttles the amount of content distributed to rating entities, which can also reduce the negative effects of objectionable content on the rating entities. For example, the evaluation apparatus can determine the amount of content distributed to the rating entities over a pre-specified amount of time, and compare the determined amount to a threshold for the amount of time. If the amount of content distributed to a particular rating entity over the pre-specified amount of time is more than the threshold, the evaluation apparatus prevents more content to be distributed to the rating entities. For example, if the pre-specified amount of time is 1 hour and the threshold for the amount of content is 15 images, the hierarchical evaluation process will distribute 15 images or less for evaluation to a particular rating entity over a one hour period.

In some implementations, the content distributed to rating entities is throttled based on a badness score. In such implementations, the badness score of the content quantifies the level of inappropriateness of the content distributed to a rating entity over a pre-specified amount of time. For example, the evaluation apparatus can determine the badness score of the content provided to a particular rating entity (or set of rating entities) based on an amount and/or intensity of objectionable content that has been passed to (or evaluated by) the particular rating entity. The badness score increases with the duration of objectionable material that has been passed to the rating entity and/or the intensity of the objectionable material.

The intensity of the objectionable material can be based on the type of objectionable material depicted (e.g., casual alcohol consumption vs. extremely violent actions), and each type of objectionable material can be mapped to a badness value. The combination of the duration and intensity can result in the overall badness score for content that has been passed to a particular rating entity. This overall badness score can be compared to a specified a maximum acceptable badness score, and when the badness score reaches the maximum acceptable badness score, the evaluation apparatus can prevent further distribution of content to that particular rating entity until their badness score falls below the maximum acceptable badness score. In some implementations, the badness score will decrease over time according to a decay function.

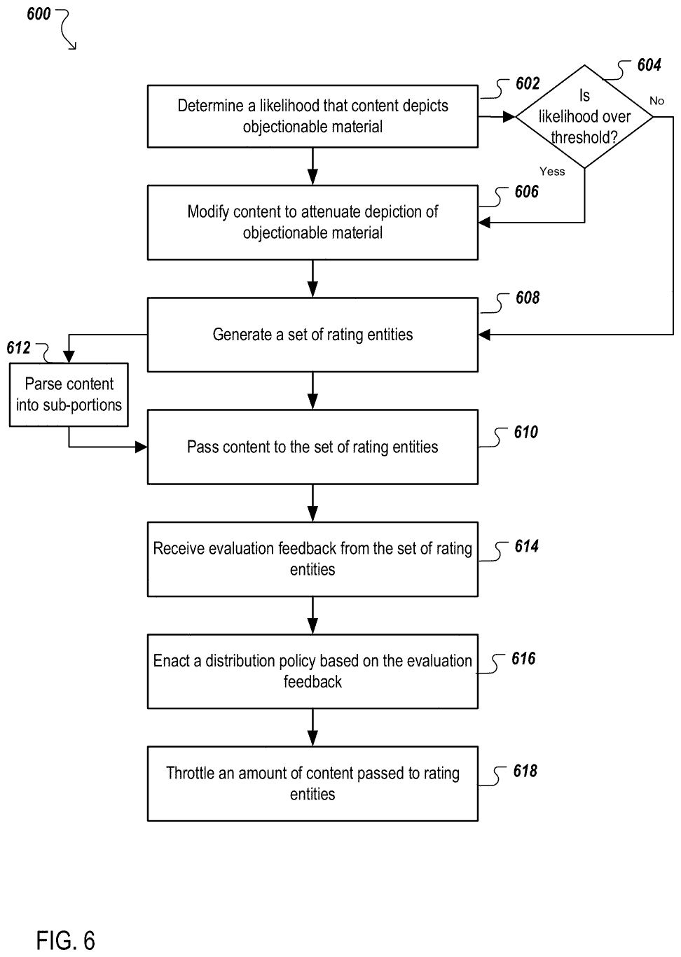

FIG. 6 is a flow chart of an example multi-tier scalable media analysis process 600. Operations of the process 600 can be performed by one or more data processing apparatus or computing devices, such as the evaluation apparatus 170 discussed above. Operations of the process 600 can also be implemented as instructions stored on a computer readable medium. Execution of the instructions can cause one or more data processing apparatus, or computing devices, to perform operations of the process 600. Operations of the process 600 can also be implemented by a system that includes one or more data processing apparatus, or computing devices, and a memory device that stores instructions that cause the one or more data processing apparatus or computing devices to perform operations of the process 600.

A likelihood that content depicts objectionable material is determined (602). In some implementations, the likelihood that content depicts objectionable material is determined using a first evaluation rule. The first evaluation rule can include one or more content guidelines and/or other rules specifying content that is not acceptable for distribution over a platform implementing the process 600. For example, the first evaluation rule may specify that excessive violence and/or drug use may be a violation of content guidelines, which would prevent distribution of the content.

As discussed in detail above, in some implementations, the likelihood of objectionable material is a numeric value that represents the overall likelihood that the content 202 fails to meet content guidelines. For example, the likelihood of objectionable material can be a number on a scale from 0-10, where a number closer to 0 indicates that the content has a lower determined likelihood of depicting objectionable material, and a number closer to 10 indicates a higher likelihood that the content depicts objectionable material.

In some implementations, the likelihood of objectionable material can be determined by an automated rating entity that utilizes various content detection algorithms. For example, the automated rating entity can utilize a skin detection algorithm, blood detection algorithm, object identification techniques, speech recognition techniques, and other appropriate techniques to identify particular objects or attributes of a media item, and classify the media item based on the analysis.

A determination is made whether the likelihood is above a specified modification threshold (604). In some implementations, the determination is made by comparing the likelihood to the modification threshold. The modification threshold is a value at which the content is considered to include objectionable content. When the modification threshold is met, there is a high confidence that the content includes objectionable content.

When the likelihood that the content depicts objectionable material is above the specified threshold the content is modified to attenuate the depiction of the objectionable material (606). As discussed above, the content can be modified, for example, by pixelating, blurring, or otherwise attenuating the vividness and/or clarity of visually objectionable material. The content can also be modified by bleeping objectionable audio content, muting objectionable audio content, reducing the volume of objectionable audio content, or otherwise attenuating the audible presentation of the objectionable audio content. In some implementations, the modification of the content can include parsing the content into sub-portions, as discussed in detail throughout this document. When the likelihood that the content depicts objectionable material is below a specified threshold, an unmodified version of the content can be maintained, and analyzed as discussed in more detail below.

A set of rating entities is generated (608). The set of rating entities includes those rating entities that will further evaluate the content for violations of content guidelines, including further determinations as to whether the content includes objectionable material. In some implementations, the set of rating entities is generated to provide for a diverse set of rating entity attributes. For example, the set of rating entities can be generated to include rating entities from different geographic regions, different generations, and/or different experience levels.

In some implementations, the set of rating entities is generated based on the aspect of the content that is to be evaluated. As such, a determination of the aspect of the content to be evaluated by the set of rating entities can be determined. The determination can be made, for example, based on the aspects of the content that have not yet been evaluated and/or aspects of the content for which a minimum acceptable rating confidence has not yet been reached. For example, if a particular aspect of the content has been evaluated, but the confidence in the classification of that aspect does not meet the minimum acceptable rating confidence, the set of rating entities can be generated in a manner that is appropriate for evaluating that particular aspect of the content (e.g., by including rating entities that have been trained to evaluate that particular aspect or have experience evaluating that particular aspect).

In some implementations, the set of rating entities is generated so that the rating entities in the set of rating entities has a specified set of attributes. For example, a determination can be made as to one or more entity attributes that are considered required to reach consensus among the set of rating entities, and the set of rating entities can be created to include only entities having the one or more entity attributes that are considered required to reach consensus among the set of rating entities in a particular context. For example, as discussed above, when content is being evaluated for whether it is eligible for distribution in geographic region A, the set of rating entities can be selected so as to only include rating entities from geographic region A so that the evaluation feedback from the set of rating entities will reflect whether the content includes objectionable material according to the social norms of geographic region A.

In some implementations, multiple sets of rating entities can be generated so as to compare the evaluation feedback from different sets of rating entities that are created based on differing rating entity attributes. For example, in addition to the set of rating entities generated based on the geo attribute of geographic region A, a second set of rating entities can be generated. That second set of rating entities can be generated so that the rating entities in the second set do not have at least one of the one or more entity attributes. For example the second set of rating entities can be required to have a geo attribute other than geographic region A, or at least one attribute that is different from all entities in the first set of rating entities (e.g., having the geo attribute geographic region A).

The content is passed to a set of rating entities (610). In some implementations, the content is passed to a single set of rating entities, and in other implementations, the content is passed to multiple different sets of rating entities. The content can be passed to the set of rating entities for further evaluation based on the likelihood that the content depicts objectionable material. The content can be passed to the set of rating entities when the likelihood of the content depicting objectionable content does not reach a level that would have already prevented distribution of the content. As discussed above, the content can be passed to the rating entities when the likelihood that the content depicts objectionable material is less than an objection threshold. The content can be passed to the set of rating entities based on other factors, such as confirming a prior classification of the content (e.g., as depicting objectionable material or a particular type of content).

The unmodified version of the content is passed to the rating entities when the likelihood of objectionable content did not reach the modification threshold at 604. When the likelihood of objectionable content reached the modification threshold at 604, the content can be modified, as discussed above, prior to passing the content to the set of rating entities, and the modified content, rather than the unmodified content will be passed to the set of rating entities.

In some implementations, the content can be optionally parsed into sub-portions (612). The parsing can be performed prior to passing the content to the set of rating entities. The parsing can be performed, for example, by segmenting the content into smaller portions of the content that each include less than all of the content. For example, as discussed above, a single video (or any other type of media) can be parsed into multiple sub-portions that each have a duration less than the duration of the video. When the content is parsed prior to passing the content to the set of rating entities, each smaller portion (sub-portion) of the content can be passed to a different subset of entities from among the set of entities for evaluation in parallel in a manner similar to that discussed above.

Evaluation feedback is received indicating whether the content violates content guidelines (614). The evaluation feedback is received from the set of rating entities. The indication of whether the content violates content guidelines can take many forms. For example, the evaluation feedback can specify a vote in favor or against the content being objectionable. For example, voting YES with respect to the content may refer to a vote that the content depicts objectionable material and voting NO with respect to the content may refer to a vote that the content does not depict objectionable material. Alternatively, or additionally, the evaluation feedback can specify a type of material depicted by the content, and/or a specific content guideline that is violated by the content. For example, the evaluation feedback can specify whether the content depicts violence or drug use.

In some implementations, the evaluation feedback can be used to determine rating entity attributes that are required to reach a consensus with respect to the evaluation of the content. For example, after obtaining evaluation feedback indicating whether the content violates a content distribution policy from each of multiple different sets of rating entities (or multiple rating entities in a same set of rating entities), the determination of whether one or more entity attributes are required to arrive at a consensus as to whether the content is objectionable (e.g., in a particular distribution context).

In some implementations, the determination reveals that the one or more attributes are required to reach consensus when the evaluation feedback obtained from one set of rating entities differs from the evaluation feedback received from another set of entities. For example, the determination may be made that rating entities in geographic region A classify the content as depicting objectionable material, while rating entities in geographic region B classify the content as depicting material that is not objectionable. In this example, in the context of geographic regions, the attribute of geographic region A is required to reach consensus as to whether content contains objectionable material with respect to the social norms associated with geographic region A.

In some implementations, the determination reviews that the one or more attributes are not required to reach consensus when the evaluation feedback obtained from one set of rating entities matches the evaluation feedback received from the other set of entities. With reference to the example above, if both sets of rating entities classified the content in the same way, the geo attribute of geographic region A would not be considered required for reaching consensus.

When the content is parsed into sub-portions, as discussed with reference to 612, separate evaluation feedback will be received for each smaller portion, and from the different subset of entities to which the smaller portions were passed. As discussed above, the evaluation feedback for each smaller portion (e.g., sub-portion) will be used to determine the overall classification of the content.

A distribution policy is enacted based on the evaluation feedback (616). In some implementations, the enactment of the distribution policy includes preventing distribution of the content when the evaluation feedback indicates that the content violates a content guideline. In some implementations, the enactment of the distribution policy includes distributing the content when the evaluation feedback indicates that the content does not violate the content guideline.

In some implementations, the distribution policy is a geo-based distribution policy that specifies different distribution policies for different geographic regions. In these implementations, the enactment of the distribution policy will be carried out depending on the geographic region to which the content is intended for distribution. For example, when it is determined that the content violates a first distribution policy for a first geographic region, but does not violate a second distribution policy for a second geographic region, distribution of the content will be prevented in the first geographic region based on the violation of the first content distribution policy, while distribution of the content in the second geographic region will occur based on the content not violating the second content distribution policy irrespective of whether the content violates the first content distribution policy of the first geographic region.

The amount of content that is passed to the set of rating entities is throttled (618). As discussed above, the amount of content can be throttled to reduce the impact of objectionable material on the rating entities. The throttling can be performed for each different entity in the set of rating entities. To carry out the throttling, an amount of content that has been passed to the different entity over a pre-specified amount of time can be determined, a badness score quantifying a level of inappropriateness of the content that has been passed to the different entity over the pre-specified amount of time can be determined, and additional content can be prevented from being passed to the different entity when (i) the amount of content that has been passed to the different entity over a pre-specified amount of time exceeds a threshold amount or (ii) the badness score exceeds a maximum acceptable badness score.

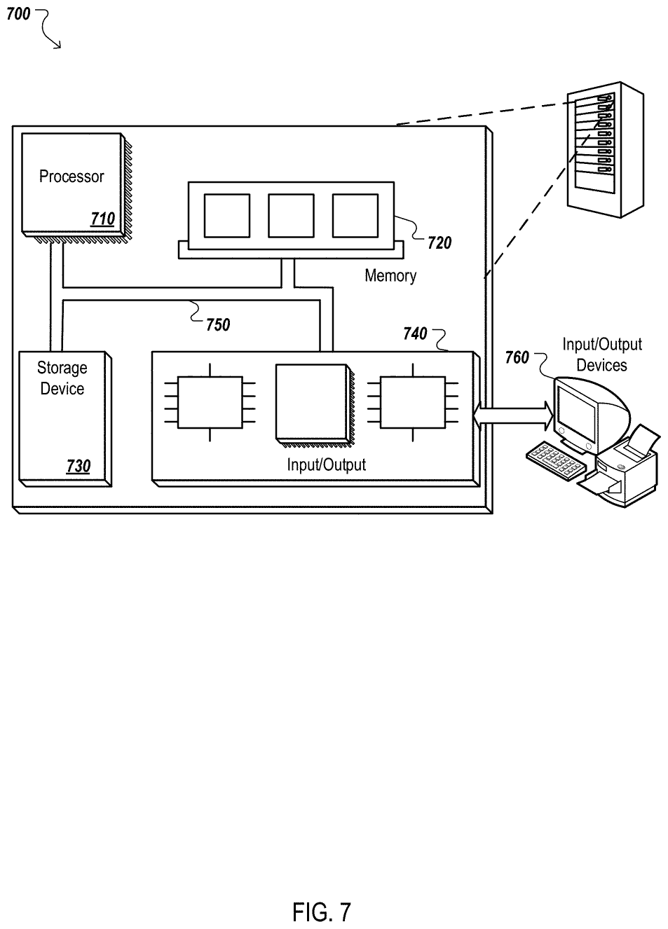

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
determining, by one or more data processors using a first evaluation rule, a likelihood that content depicts objectionable material;
passing, by the one or more data processors, the content to a set of rating entities for further evaluation based on the likelihood that the content depicts objectionable material, including:
when the likelihood that the content depicts objectionable material is below a specified modification threshold, passing an unmodified version of the content to the set of rating entities; and
when the likelihood that the content depicts objectionable material is above the specified modification threshold:
modifying the content to attenuate the depiction of the objectionable material; and
passing the modified content to the set of rating entities;
receiving, by the one or more data processors and from the set of rating entities, evaluation feedback indicating whether the content violates content guidelines; and
enacting, by the one or more data processors, a distribution policy based on the evaluation feedback, including:
preventing distribution of the content when the evaluation feedback indicates that the content violates a content guideline; and
distributing the content when the evaluation feedback indicates that the content does not violate the content guideline.

2. The method of claim 1, wherein:
enacting a distribution policy comprises enacting a geo-based distribution policy that specifies different distribution policies for different geographic regions, the method further comprising:
determining, based on the evaluation feedback, that the content violates a first content guideline for a first geographic region, but does not violate a second content guideline for a second geographic region, wherein:
preventing distribution of the content when the evaluation feedback indicates that the content violates a content guideline comprises preventing distribution of the content in the first geographic region based on the violation of the first content guideline; and
distributing the content when the evaluation feedback indicates that the content does not violate the content guideline comprises distributing the content in the second geographic region based on the content not violating the second content guideline irrespective of whether the content violates the first content guideline of the first geographic region.

3. The method of claim 1, further comprising generating the set of rating entities, including:
determining one or more entity attributes that are considered required to reach consensus among the set of rating entities in a first context; and
creating the set of rating entities to include only entities having the one or more entity attributes that are considered required to reach consensus among the set of rating entities in the particular context.

4. The method of claim 3, further comprising:
generating a second set of rating entities that do not have at least one of the one or more entity attributes;
obtaining, from the second set of rating entities, evaluation feedback indicating whether the content violates a content guideline; and
determining whether the one or more entity attributes are required to reach consensus based on the evaluation feedback obtained from the second set of rating entities, including:
determining that the one or more attributes are required to reach consensus when the evaluation feedback obtained from the second set of rating entities differs from the evaluation feedback received from the set of entities; and
determining that the one or more attributes are not required to reach consensus when the evaluation feedback obtained from the second set of rating entities matches the evaluation feedback received from the set of entities.

5. The method of claim 1, further comprising:
parsing the content into smaller portions of the content that each include less than all of the content, wherein:
passing the content to a set of rating entities for further evaluation comprises passing each smaller portion of the content to a different subset of entities from among the set of entities for evaluation in parallel; and
receiving evaluation feedback indicating whether the content violates a content guideline comprises receiving separate feedback for each smaller portion from the different subset of entities to which the smaller portion was passed.

6. The method of claim 1, further comprising throttling an amount of content that is passed to the set of rating entities.

7. The method of claim 6, wherein throttling the amount of content that is passed to the set of rating entities comprises:
for each different entity in the set of entities:
determining an amount of content that has been passed to the different entity over a pre-specified amount of time;
determining a badness score quantifying a level of inappropriateness of the content that has been passed to the different entity over the pre-specified amount of time; and
preventing additional content from being passed to the different entity when (i) the amount of content that has been passed to the different entity over a pre-specified amount of time exceeds a threshold amount or (ii) the badness score exceeds a maximum acceptable badness score.

8. The method of claim 1, wherein determining the likelihood that content depicts objectionable material comprises:
executing, by the one or more data processors, an automated rating entity that utilizes one or more of a skin detection algorithm, blood detection algorithm, object identification analysis, or speech recognition analysis.

9. The method of claim 1, wherein modifying the content to attenuate the depiction of the objectionable material comprises any of one of blurring, pixelating, or muting, a portion of the content.

10. A system, comprising:
a data store storing one or more evaluation rules; and
one or more data processors configured to interact with the one or more evaluation rules, and perform operations comprising:
determining, using a first evaluation rule, a likelihood that content depicts objectionable material;
passing the content to a set of rating entities for further evaluation based on the likelihood that the content depicts objectionable material, including:
when the likelihood that the content depicts objectionable material is below a specified modification threshold, passing an unmodified version of the content to the set of rating entities; and
when the likelihood that the content depicts objectionable material is above the specified modification threshold:
modifying the content to attenuate the depiction of the objectionable material; and
passing the modified content to the set of rating entities;
receiving, from the set of rating entities, evaluation feedback indicating whether the content violates content guidelines; and
enacting a distribution policy based on the evaluation feedback, including:
preventing distribution of the content when the evaluation feedback indicates that the content violates a content guideline; and
distributing the content when the evaluation feedback indicates that the content does not violate the content guideline.

11. The system of claim 10, wherein:
enacting a distribution policy comprises enacting a geo-based distribution policy that specifies different distribution policies for different geographic regions;
the one or more data processors are configured to perform operations comprising determining, based on the evaluation feedback, that the content violates a first content guideline for a first geographic region, but does not violate a second content guideline for a second geographic region;
preventing distribution of the content when the evaluation feedback indicates that the content violates a content guideline comprises preventing distribution of the content in the first geographic region based on the violation of the first content guideline; and
distributing the content when the evaluation feedback indicates that the content does not violate the content guideline comprises distributing the content in the second geographic region based on the content not violating the second content guideline irrespective of whether the content violates the first content guideline of the first geographic region.

12. The system of claim 10, wherein the one or more data processors are configured to perform operations comprising generating the set of rating entities, including:
determining one or more entity attributes that are considered required to reach consensus among the set of rating entities in a first context; and
creating the set of rating entities to include only entities having the one or more entity attributes that are considered required to reach consensus among the set of rating entities in the particular context.

13. The system of claim 12, wherein the one or more data processors are configured to perform operations comprising:
generating a second set of rating entities that do not have at least one of the one or more entity attributes;
obtaining, from the second set of rating entities, evaluation feedback indicating whether the content violates a content guideline; and
determining whether the one or more entity attributes are required to reach consensus based on the evaluation feedback obtained from the second set of rating entities, including:
determining that the one or more attributes are required to reach consensus when the evaluation feedback obtained from the second set of rating entities differs from the evaluation feedback received from the set of entities; and
determining that the one or more attributes are not required to reach consensus when the evaluation feedback obtained from the second set of rating entities matches the evaluation feedback received from the set of entities.

14. The system of claim 10, wherein the one or more data processors are configured to perform operations comprising:
parsing the content into smaller portions of the content that each include less than all of the content, wherein:
passing the content to a set of rating entities for further evaluation comprises passing each smaller portion of the content to a different subset of entities from among the set of entities for evaluation in parallel; and
receiving evaluation feedback indicating whether the content violates a content guideline comprises receiving separate feedback for each smaller portion from the different subset of entities to which the smaller portion was passed.

15. The system of claim 10, wherein the one or more data processors are configured to perform operations comprising throttling an amount of content that is passed to the set of rating entities.

16. The system of claim 15, wherein throttling the amount of content that is passed to the set of rating entities comprises:
for each different entity in the set of entities:
determining an amount of content that has been passed to the different entity over a pre-specified amount of time;
determining a badness score quantifying a level of inappropriateness of the content that has been passed to the different entity over the pre-specified amount of time; and
preventing additional content from being passed to the different entity when (i) the amount of content that has been passed to the different entity over a pre-specified amount of time exceeds a threshold amount or (ii) the badness score exceeds a maximum acceptable badness score.

17. A non-transitory computer readable medium storing instructions that, when executed by one or more data processing apparatus, cause the one or more data processing apparatus to perform operations comprising:
determining, using a first evaluation rule, a likelihood that content depicts objectionable material;
passing the content to a set of rating entities for further evaluation based on the likelihood that the content depicts objectionable material, including:
when the likelihood that the content depicts objectionable material is below a specified modification threshold, passing an unmodified version of the content to the set of rating entities; and
when the likelihood that the content depicts objectionable material is above the specified modification threshold:
modifying the content to attenuate the depiction of the objectionable material; and
passing the modified content to the set of rating entities;
receiving, from the set of rating entities, evaluation feedback indicating whether the content violates content guidelines; and
enacting a distribution policy based on the evaluation feedback, including:
preventing distribution of the content when the evaluation feedback indicates that the content violates a content guideline; and
distributing the content when the evaluation feedback indicates that the content does not violate the content guideline.

18. The non-transitory computer readable medium of claim 17, wherein:
enacting a distribution policy comprises enacting a geo-based distribution policy that specifies different distribution policies for different geographic regions;
the instructions cause the one or more data processing apparatus to perform operations comprising determining, based on the evaluation feedback, that the content violates a first content guideline for a first geographic region, but does not violate a second content guideline for a second geographic region;
preventing distribution of the content when the evaluation feedback indicates that the content violates a content guideline comprises preventing distribution of the content in the first geographic region based on the violation of the first content guideline; and
distributing the content when the evaluation feedback indicates that the content does not violate the content guideline comprises distributing the content in the second geographic region based on the content not violating the second content guideline irrespective of whether the content violates the first content guideline of the first geographic region.

19. The non-transitory computer readable medium of claim 17, wherein the instructions cause the one or more data processing apparatus to perform operations comprising generating the set of rating entities, including:
determining one or more entity attributes that are considered required to reach consensus among the set of rating entities in a first context; and
creating the set of rating entities to include only entities having the one or more entity attributes that are considered required to reach consensus among the set of rating entities in the particular context.

20. The non-transitory computer readable medium of claim 19, wherein the instructions cause the one or more data processing apparatus to perform operations comprising:
generating a second set of rating entities that do not have at least one of the one or more entity attributes;
obtaining, from the second set of rating entities, evaluation feedback indicating whether the content violates a content guideline; and
determining whether the one or more entity attributes are required to reach consensus based on the evaluation feedback obtained from the second set of rating entities, including:
determining that the one or more attributes are required to reach consensus when the evaluation feedback obtained from the second set of rating entities differs from the evaluation feedback received from the set of entities; and
determining that the one or more attributes are not required to reach consensus when the evaluation feedback obtained from the second set of rating entities matches the evaluation feedback received from the set of entities.
